(19) United States
(12) Patent Application Publication
(10) Pub. No.: US 2012/0077099 A1
(43) Pub. Date: Mar. 29, 2012

(54) SOLID OXIDE FUEL CELL WITH MULTIPLE FUEL STREAMS

(75) Inventors: Aaron Crumm, Ann Arbor, MI (US); Shaowu Zha, Ann Arbor, MI (US); Timothy LaBreche, Ann Arbor, MI (US)

(73) Assignee: ADAPTIVE MATERIALS, INC., Ann Arbor, MI (US)

(21) Appl. No.: 12/888,531

(22) Filed: Sep. 23, 2010

(51) Int. Cl. H01M 8/06

(52) U.S. Cl. 429/423

(57) ABSTRACT

Disclosed herein is a solid oxide fuel cell including an electrochemical cell, a first fuel reformer, and a first feed tube. The electrochemical cell includes an anode, a cathode, and an electrolyte. The anode at least partially defines an anode chamber. The anode is configured to convert a reformed fuel to an exhaust fluid comprising water. The fuel reformer is configured to receive raw fuel and to convert raw fuel to reformed fuel. The fuel reformer is disposed within the anode chamber. The first feed tube is disposed within the anode chamber. The first feed tube is configured to route raw fuel downstream the first fuel reformer such that raw fuel reacts with water of the exhaust fluid.

### FIELD OF INVENTION

This disclosure is related to a solid oxide fuel cell with fuel reforming.

### BACKGROUND

The statements in this section merely provide background information related to the present disclosure and may not constitute prior art. Fuel cells create an electromotive force across an electrolyte by reacting a fuel, typically hydrogen, at an anode disposed on a first side of the electrolyte, and an oxidant, typically oxygen at a cathode disposed on a second side of the electrolyte. In portable fuel cell systems, fuel, for example hydrogen gas or hydrogen and other molecules can be stored in a suitable holding tank and transported along with the fuel cell system. The fuel can be utilized for the anode reactions and oxygen from the atmosphere can be utilized for the cathode reactions.

Reforming fuel inside a solid oxide fuel cell as described in U.S. Pat. No. 7,547,484 entitled Solid Oxide Fuel Cell with Internal Fuel Processing, the entire contents of which is hereby incorporated by reference herein, have several advantages over systems that do not utilize internal reformers. For example, fuel cell systems having internal reformers allow utilization of a portable hydrocarbon fuel having a high energy storage density. Due to limitations in current hydrogen storage methods, utilizing hydrocarbon-based fuel in fuel cells can provide advantages over utilizing hydrogen stored in molecular and solid-state form. Hydrocarbon fuels, as used herein, refer to any of a broad range of molecules containing hydrogen and carbon utilized in fuel and can include oxygenated hydrocarbons such as alcohols and glycols. Hydrocarbon fuels have high energy-to-volume ratios when compared to hydrogen gas and can be stored utilizing inexpensive storage containers when compared to compressed gas or liquid hydrogen. Further, hydrocarbons have a high energy-to-weight ratio and can be stored utilizing inexpensive storage systems when compared to solid-state hydrogen storage systems.

In the internal reforming system described in U.S. Pat. No. 7,547,484, a hydrocarbon such as propane is partially oxidized and converted to hydrogen utilizing a reformer disposed within an electrochemical cell of the fuel cell system. Reactants for the fuel cell including hydrogen and carbon monoxide can be liberated from the hydrocarbon fuels in a fuel reformer. The fuel reformer can comprise a catalyst material that catalyzes the reaction between oxygen and the hydrocarbon fuel to partially oxidize the hydrocarbon fuel to generate hydrogen. Atmospheric oxygen can be provided to the fuel reformer. The hydrogen reacts with oxygen to form water which is routed out of the fuel cell as a waste product. Although small amounts of water vapor present in the internal chamber of the fuel cell can react with carbon monoxide fuel to generate hydrogen at high efficiency, a majority of the water vapor is dispersed outside the fuel cell tube as exhaust fluid.

The art would benefit from higher efficiency solid oxide fuel cells with internal reforming. Higher efficiency solid oxide fuel cells can lead to fuel cells having lower costs, lower weights and higher fuel efficiency.

### DESCRIPTION OF THE FIGURES

FIG. 1 depicts a solid oxide fuel cells stack in accordance with an exemplary embodiment of the present disclosure;

FIG. 2 depicts an exploded view of a portion of the fuel cell stack of FIG. 1;

FIGS. 3A and 3B depicts exploded views of a fuel cell module of the fuel cell stack of FIG. 1; and

FIG. 4 depicts a cross-sectional view of the fuel cell module of FIGS. 3A and 3B.

### SUMMARY

Disclosed herein is a solid oxide fuel cell including an electrochemical cell, a first fuel reformer, and a first feed tube. The electrochemical cell includes an anode, a cathode, and an electrolyte. The anode at least partially defines an anode chamber. The anode is configured to convert a reformed fuel to an exhaust fluid comprising water. The fuel reformer is configured to receive raw fuel and to convert raw fuel to reformed fuel. The fuel reformer is disposed within the anode chamber. The first feed tube is disposed within the anode chamber. The first feed tube is configured to route raw fuel downstream the first fuel reformer such that raw fuel reacts with water of the exhaust fluid.

### DESCRIPTION

Referring to Figures, wherein like elements are numbered alike, a solid oxide fuel cell stack 10 allows hydrocarbon fuel reformation through an upstream partial oxidation reaction and a downstream steam reforming reaction. As used herein, the terms “upstream” and “downstream” refer to the position of components of the fuel cell stack 10 relative to the general direction of fluid flow in the solid oxide fuel cell stack 10. Further terms such as “first”, “second”, and the like, are also used to describe various elements, regions, sections, etc and are also not intended to be limiting. Since the terms are not meant to be limiting, an element may be described as “first” in the claims but may refer to any like element within the scope of the specification and is not intended to be limited only to elements referred to as “first” in the specification.

In one embodiment, the solid oxide fuel cell stack 10 routes fuel past a fuel utilization portion of an electrochemical cell (that is, a portion of the electrochemical cell in which reformed fuel reacts at the anode to form exhaust fluid) so that the fuel can be directly fed into an exhaust fluid stream and can be reformed by water within the exhaust fluid. Reforming raw fuel to hydrogen utilizing water is much more efficient than reforming hydrogen utilizing only oxygen. Therefore, the solid oxide fuel cell stack 10 can achieve higher fuel utilization efficiency levels than previous fuel cell stacks with partial oxidation internal reforming.

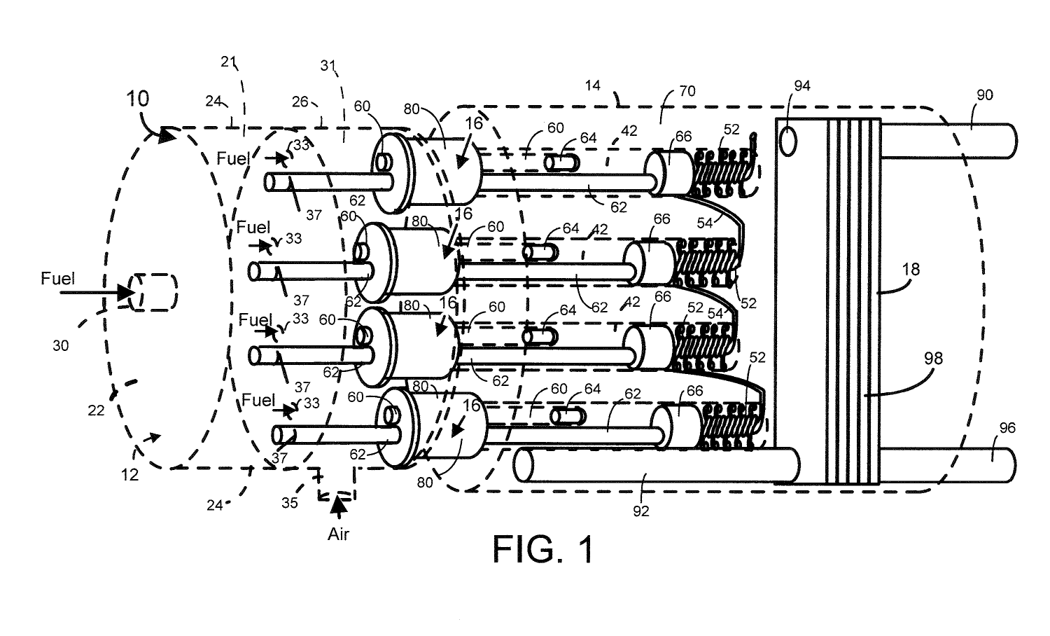

Referring to FIG. 1, the solid oxide fuel cell stack 10 includes a manifold 12, an insulated housing 14, a plurality of fuel cell modules (each of which is labeled and referred to as 16), and a heat recuperator 18. In FIG. 1, dashed lines are used to indicate transparent depictions of fuel cell stack 10 components. In particular, the manifold 12, the insulated housing 70, a fuel cell tube 42 of the fuel cell module 16, and a first feed tube 62 of the fuel cell module 16 are depicted as dashed lines. Components of the fuel cell stack 10 are depicted as transparent are only meant to illustrate features inside the components and do not necessarily reflect material properties of the fuel cell stack components.

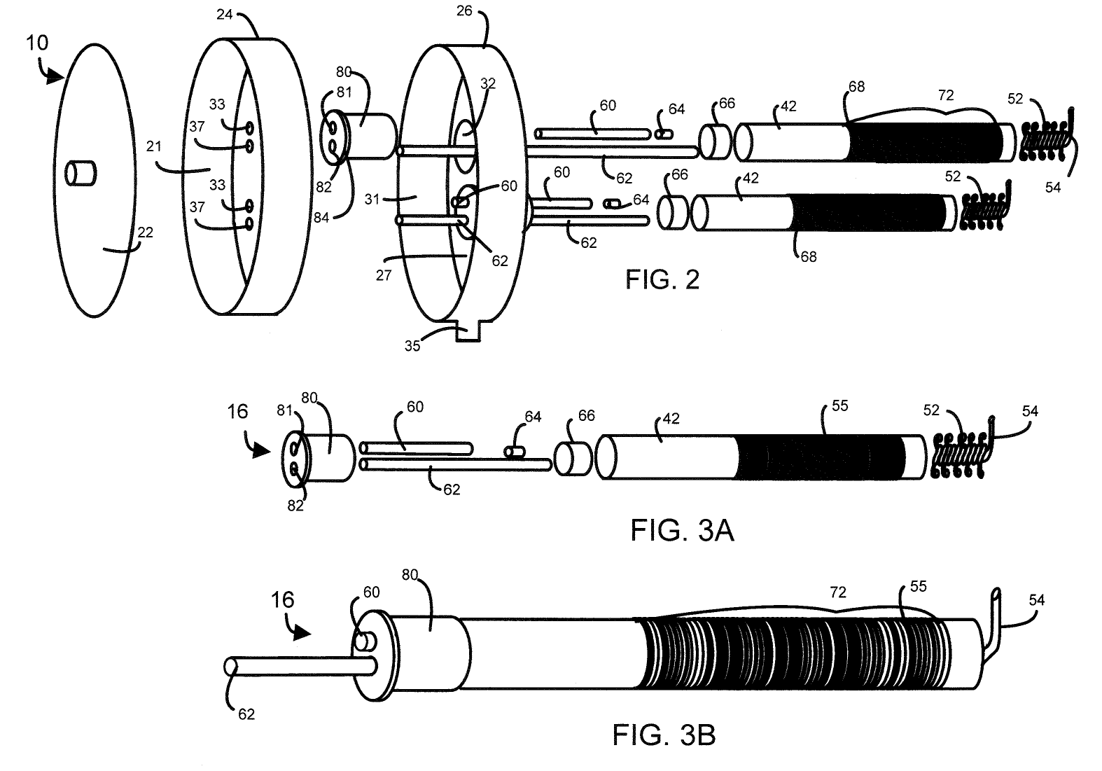

Referring to FIGS. 1 and 2, the manifold 12 is configured to receive air and fuel at a manifold inlet member 30 and to distribute air and fuel to each of the fuel cell tube modules 16. The manifold 12 comprises a fuel stage 24 defining a fuel chamber 21 and an air and fuel stage 26 defining an air and fuel chamber 31. The fuel chamber 21 comprises a fuel inlet 30 and a plurality of fuel outlet opening 33 and fuel feed tube openings 37. The fuel outlet openings 37 are sized to provide a desired pressure drop for fuel introduction into the air and fuel chamber 31, thereby allowing the fuel chamber to buffer dynamics in fuel level delivered to the fuel cell modules 16.

The air and fuel air fuel stage 26 includes an air inlet 35 such that is introduced into the air and fuel chamber 31 and mixes with fuel introduced through the openings 33. The air and fuel stage 26 further includes a base wall 27 and having a plurality of manifold outlet portions 32 disposed therethrough.

The insulative housing 14 provides a thermal barrier for high temperature portions of the solid oxide fuel cell stack 10. The insulative housing 14 defines an insulative chamber 70. In an exemplary embodiment, the insulative housing 14 comprises a high temperature microporous insulation material. In alternate embodiments, the insulative housing 14 can comprise high-temperature, ceramic-based material, for example, foam, aero-gel, mat-materials, and fibers formed from, for example, alumina, silica, and like materials.

Referring to FIGS. 2, 3A, 3B, and 4, each fuel cell tube module 16 comprises an end cap 80, a fuel cell tube 42, a first feed tube 60, a second feed tube 62, a first reformer 64, a second reformer 66, a first anode current collector 52, an interconnect member 54, and a cathode current collector 55.

The end cap 80 provides a sealed connection between the manifold chamber 25 and an anode chamber 45 of the fuel cell tube 42. In particular, the end cap 80 includes a first hole 81 for routing the first feed tube 60 therethrough, a second hole 82 for routing a second feed tube 62 therethrough, and a lip member 84 for overlapping with the base wall 27 of the air and fuel chamber 26. In one embodiment, the end cap 80 can comprise a resilient material to provide a gas-tight seal around outer circumferences of the feed tube 60 and the feed tube 62 and around the inner circumference of the fuel cell tube 42. Further, the resilient materials provide a gas-tight seal around an inner circumference of the fuel cell tube 42. In one embodiment, the end cap 80 comprises a high-temperature polymer material such as a silicone based material configured for structural stability at temperatures of about 200-250 degrees Celsius. In one embodiment, the end cap 80 can comprise other natural or synthetic polymers such as rubber or polyurethane. A sealant material (not shown) can be disposed between the end cap 80 and the base wall 27, between the end cap 80 and the first fuel feed tube 60, between the end cap 80 and second feed tube 62, and between the end cap 80 and the fuel cell tube 42. In an exemplary embodiment the sealant material 83 comprises a Room Temperature Vulcanizing (‘RTV’) silicone-based sealant. In alternate embodiments, the sealant material can comprise various metals, high temperature polymers, glass, and ceramic sealant materials. Further, multiple types of sealants materials can be utilized to seal the end cap 80 and can be utilized throughout the fuel cell stack 10.

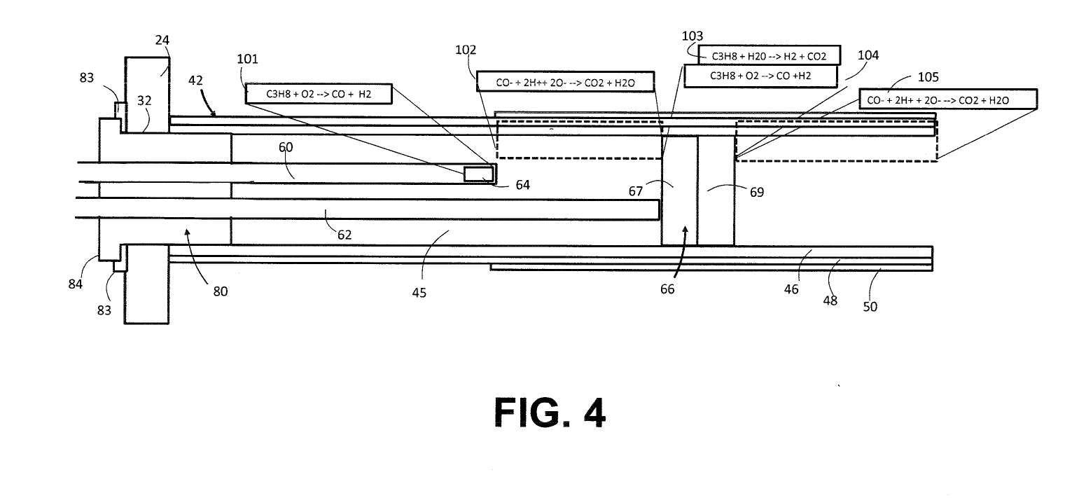

Referring to FIG. 4, the fuel cell tube 42 includes an anode 46, an electrolyte 48, and a cathode 50. The fuel cell tube 42 comprises a tubular structure defining the anode chamber 45. Anode chamber, as used herein, refers to the fuel-receiving portion of each fuel cell of a fuel cell stack that is at least partially defined by a fuel cell anode and can comprise any one of a variety of geometries, (for example, cylindrical, tubular or planar geometries). During operation, the portion of the fuel cell tube 42 comprising anode 46, electrolyte 48, and cathode 50 are disposed in outwardly defined concentric layers to define an electrochemical active portion 72. The electrochemical active portion 72 is the portion of the fuel cell tube 42 which generates power by reacting with fuel at the anode and oxygen at the cathode. Each fuel cell tube 42 can be formed utilizing method described in U.S. Pat. No. 6,749,799 to Crumm et al., entitled METHOD FOR PREPARATION OF SOLID STATE ELECTROCHEMICAL DEVICE, the entire contents of which is hereby incorporated by reference, herein.

The anode 46 comprises an electrically and ionically conductive cermet that is chemically stable in a reducing environment. In an exemplary embodiment, the anode 46 includes a conductive metal such as nickel, disposed within a ceramic skeleton, such as yttria-stabilized zirconia. Exemplary materials for the electrolyte 48 includes zirconium-based materials and cerium-based materials such as, for example, yttria-stabilized zirconia and gadolinium doped ceria, and can further include various other dopants and modifiers to affect ion conducting properties. The anode 46 and the cathode 50, which form phase boundaries (gas/electrolyte/electrode particles; commonly known as triple points) with the electrolyte 48 are disposed on opposite sides of the electrolyte portion 48 with respect to each other.

In general, the anode 46 and cathode 50 are formed of porous materials capable of functioning as an electrical conductor and capable of facilitating the appropriate reactions. The porosity of these materials allows dual directional flow of gases (e.g., fuel or oxidant gases inflow and byproduct gases exiting).

The cathode 50 comprises a conductive material that is chemically stable in an oxidizing environment. In an exemplary embodiment, the cathode comprises a perovskite material and specifically comprises lanthanum strontium cobalt ferrite (LSCF). In an exemplary embodiment, each of the anode, the electrolyte, and the cathode are disposed within a range, of about 5-50 micrometers. An intermediate layer (not shown) may be disposed between the cathode 50 and the electrolyte 48 to decrease reactivity between material of the cathode 50 and material in the electrolyte 48. In an exemplary embodiment, intermediate layer (not shown) comprises strontium-doped cobaltate (SDC), and is disposed at a thickness within the range of 1-8 micrometers.

The first feed tube 60 and the second feed tube 62 comprise material generally compatible with the operating environment of the fuel cell stack 10. In an exemplary embodiment, the first feed tube 60 and the second feed tube 62 comprise alumina. In an alternate embodiment, the first feed tube 60 and the second feed tube 62 comprise another ceramic or another high temperature material such as a high temperature metal alloy.

The first feed tube 60 includes the internal reformer 64 disposed therein such that the first feed tube 60 can route air and raw fuel from the inner chamber 25 of the manifold 12 to the internal reformer 64. The second feed tube 62 routes fuel and air from the inner chamber 25 of the manifold 30 to the internal reformer 66.

The exemplary first internal reformer 64 partially oxidizes raw fuel thereby converting the raw fuel to a reformed fuel mixture comprising hydrogen. The raw fuel can comprise any one of a number of different fuel such as propane, butane, ethanol, methanol, military JP-8 and JP-5 fuels, gasoline, and diesel fuel.

When exemplary propane fuel is utilized as shown in box 101 of FIG. 4, the propane (‘C₃H₈’) and oxygen (‘O₂’) are converted to a reformed fuel mixture comprising carbon monoxide (‘CO’) and hydrogen (‘H₂’). The hydrogen and the carbon monoxide generated at first internal reformer 64 are converted to carbon dioxide (‘CO₂’) and water (‘H₂O’) at the anode 46 as depicted in box 102.

The exemplary second internal reformer 66 oxidizes raw fuel by converting raw fuel and water to a reformed fuel mixture comprising hydrogen and carbon dioxide. When exemplary propane fuel is utilized as raw fuel as shown in box 103 of FIG. 4, the propane (‘C₃H₈’) and water (‘H₂O’) are converted to a reformed fuel mixture comprising hydrogen gas (‘H₂’) and carbon dioxide (‘CO₂’). In addition to converting raw fuel and water to the reformed fuel mixture comprising hydrogen and carbon monoxide, the second internal reformer 66 can convert propane and oxygen to hydrogen and carbon monoxide as shown in box 104 of FIG. 4. Therefore, in an exemplary embodiment, raw fuel is converted simultaneously by both partial oxidation and by steam reforming at the second internal reformer 66.

The first internal reformer 64 and the second internal reformer 66 each comprise a metallic catalyst material such as platinum, rhodium, rubidium, nickel and the like disposed on a ceramic substrate such as an alumina, ceria or a zirconia substrate. Further, the specific catalyst formulations of the first internal reformer 64 can be tailored for partial-oxidation reforming reactions and the second internal reformer can be tailored for water-based reforming reactions.

Each of the first internal reformer 64 and the second internal reformer 66 can be designed and located within the feed tube to manage catalytic reactions and thermal distribution within the fuel cell stack 14. Material compositions for the first internal reformer 64 and the second internal reformer 66 capable of the operating characteristics described above will be apparent to those skilled in the art. The second internal reformer 66 comprises a catalyst loaded body, wherein the body can comprise a porous substrate, extruded substrate, fiber, matt or other materials that can be utilized as catalyst bodies.

The second internal reformer 66 comprises a mixing portion 67 wherein exhaust fluid mixes with raw fuel and a reforming portion 69 where catalyst loading is concentrated to promote water-based fuel reforming. In one embodiment, water-based fuel reforming

The anode current collector 52 comprises material generally configured to collect and conduct electrons between anode layer 46 of a first fuel cell tube and either a cathode layer or an anode layer of a second fuel cell tube depending on whether the fuel cell tubes are connected in series or parallel electrical connections. In one embodiment, the anode current collector 52 comprises copper. The anode current collector is substantially similar to that described in U.S. Published Application Number 20070141447 SOLID OXIDE FUEL CELL WITH IMPROVED CURRENT COLLECTION, which hereby incorporated by reference herein.

The anode current collector 52 comprises a wire brush structure having an inner conductive core and outer resilient brush bristles that can provide desired locating and tolerancing characteristics to enhance connection within the inner wall of the fuel cell tube 42. The anode current collector 52 can be inserted into the fuel cell tube 42 through either the fuel cell tube inlet or the exhaust outlet. When inserted into the fuel cell tube 42, the anode current collector 52 provides structural support to the fuel cell tube 42 and supports positioning of the internal reformer 66.

An anode contact layer (not shown) can be deposited within the fuel cell tube 42 by injecting a slurry into the fuel cell tube 42 at either end of the fuel cell tube 42 and subsequently flowing air or other fluid through the fuel cell tube 42 such that the air forces the selected amount of slurry through the fuel cell tube 42 thereby selectively depositing a portion of the slurry onto portions of the anode current collector 52 and the anode 46, while allowing a portion of the slurry to exit the tube. By flowing air through the fuel cell tube 42, the slurry can be distributed on surfaces throughout the entire length of the anode current collector 52 coating the loop members filling the gap area between the anode current collector 52 and the anode layer 46. When the slurry is sintered, the anode current collector 52 is fixedly positioned within the fuel cell tube and the sintered slurry provides high levels of electrical conductivity between the anode current collector 52 and the fuel cell tube 42.

The slurry can comprise conductive material compatible with the anode 46 along with organic or aqueous solvents and corresponding binders. The binder and solvent are burned off and nickel oxide is reduced to nickel when the fuel cell tube 42 is sintered in a reducing environment. In alternate embodiments, other joining methods can be utilized to electrically and physically couple the anode current collector 52 to the anode layer 46. For example, other brazing or welding methods can be utilized. Exemplary braze materials include braze materials comprising nickel with or without a secondary material and can further include any one or more of silver, sulfur, silicon chromium, and bismuth.

The interconnect member 54 electrically and physically connects the anode current collector 52 and the cathode current collector 55. A flame protection member (not shown) is provided to protect the fuel cell tubes 42 and the current collection components of the fuel system 10 from a high temperature, combustion environment of a region proximate outlet ends of the fuel cell tube region.

The cathode current collector 55 includes a longitudinal portion and an axial portion in a substantially similar configuration to that described in U.S. Published Application Number 20070141447 which is hereby incorporated by reference herein.

The recuperator 18 includes an air inlet member 90, an air outlet member 92, an exhaust inlet member 94, an exhaust outlet member 96, and a body portion 98. The body portion 98 comprises a plate and frame heat exchanger such that when atmospheric air enters the air inlet member 90 it exchanges heat over several stages of plates and frames of a heat exchanger with exhaust fluid from the fuel cells that enters from the exhaust inlet member 94. The air exists the recuperator 18 through the air outlet member 92 and exhaust exists the recuperator 18 through the exhaust outlet member 96.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A solid oxide fuel cell comprising:
an electrochemical cell comprising an anode, a cathode, and an electrolyte, the anode at least partially defining an anode chamber, the anode chamber being configured to convert a reformed fuel to an exhaust fluid comprising water;
a first fuel reformer configured to receive a raw fuel and to convert the raw fuel to a reformed fuel, the first fuel reformer being disposed within the anode chamber; and
a first feed tube disposed within the anode chamber, the first feed tube being configured to route the raw fuel downstream the first fuel reformer such that the raw fuel reacts with water of the exhaust fluid.

2. The solid oxide fuel cell of claim 1, further comprising a second fuel reformer configured to receive the raw fuel and water and configured to catalyze a reforming reaction between the raw fuel and water.

3. The solid oxide fuel cell of claim 2, wherein the first fuel reformer and the second fuel reformer comprise a catalyst configured to increase the raw fuel to reformed fuel conversion rate.

4. The solid oxide fuel cell of claim 1, further comprising a second fuel reformer and a second feed tube configured to route fuel to the second fuel reformer.

5. The solid oxide fuel cell of claim 4, wherein the second fuel reformer is disposed within the second feed tube.

6. The solid oxide fuel cell of claim 4, further comprising an end cap, wherein the first feed tube and the second feed tube are disposed through the end cap.

7. The solid oxide fuel cell of claim 1, further comprising an anode current collector contacting the anode and routing current from the anode of the fuel cell tube.

8. The solid oxide fuel cell of claim 7, wherein the anode current collector supports the positioning of the second fuel reformer within the anode chamber.

9. The solid oxide fuel cell of claim 7, wherein the fuel cell is a tubular fuel cell.

10. A solid oxide fuel cell stack comprising:
a plurality of electrochemical cells, each electrochemical cell comprising an anode, a cathode, and an electrolyte, each anode at least partially defining an anode chamber, each anode chamber being configured to convert a reformed fuel to an exhaust fluid comprising water;
a first plurality of fuel reformers configured to receive raw fuel and to convert raw fuel to reformed fuel, one fuel reformer of the first plurality of fuel reformers being disposed within each anode chamber; and
a first plurality of feed tubes, one feed tube of the first plurality being disposed within the anode chamber of each feed tube, the first feed tube being configured to route fuel downstream the first fuel reformer such that the unreformed fuel reacts with water of the exhaust fluid.

11. The solid oxide fuel cell of claim 10, further comprising a manifold member configured to distribute air and fuel to each of the electrochemical cells.

12. The solid oxide fuel cell of claim 10, further comprising a second fuel reformer and a feed tube being configured to route fuel to the first fuel reformer.

13. The solid oxide fuel cell of claim 12, further comprising an end cap connecting the internal reformer to the fuel cell tube, wherein the first feed tube and the second feed tube are disposed through the end cap.

14. The solid oxide fuel cell of claim 12, further comprising a second fuel reformer configured to receive a raw fuel and water and catalyze a reforming reaction between the raw fuel and water.

15. The solid oxide fuel cell of claim 14, wherein the first fuel reformer and the second fuel reformer comprise a metal catalyst configured to convert raw fuel to reformed fuel.

16. The solid oxide fuel cell of claim 11, further comprising a second fuel reformer; and a second feed tube being configured to route fuel to the second fuel reformer.

17. The solid oxide fuel cell of claim 11, further comprising an anode current collector contacting the anode of a first feed tube of the plurality and routing current between the anode of the first fuel cell tube of the plurality and an electrode of a second fuel cell tube of the plurality.

18. The solid oxide fuel cell of claim 11, wherein the anode current collector supports the positioning of the second fuel reformer within the anode chamber.

19. The solid oxide fuel cell of claim 11, wherein the fuel cells are tubular fuel cell.

20. A solid oxide fuel cell stack comprising:
a manifold routing fuel and air to a plurality of manifold outlets;
a tubular electrochemical cell comprising an anode, a cathode, and an electrolyte, the anode at least partially defining an anode chamber, the anode chamber being configured to convert a reformed fuel to an exhaust fluid comprising water;
a first feed tube having a feed tube inlet, a feed tube outlet, and a first fuel reformer disposed therein, the first feed tube is configured to receive air and fuel from the manifold and route air and fuel to first fuel reformer, the first fuel reformer being configured to convert raw fuel to reformed fuel, the reformed fuel being routed to the anode of the fuel cell tube;
a second feed tube having a feed tube inlet and a feed tube outlet, the second feed tube directing raw fuel to a second fuel reformer disposed inside the fuel cell tube;
a plurality of tubular electrochemical cells receiving fuel and air from the plurality of manifold outlets, each electrochemical cell comprising an anode, a cathode, and an electrolyte, the anode defining an anode chamber, the anode chamber being configured to convert a reformed fuel to an exhaust fluid comprising water;
a first fuel reformer being configured to receive raw fuel and being configured to convert raw fuel to reformed fuel, the first fuel reformer being disposed within the anode chamber; and
a first feed tube disposed inside the anode chamber, the first feed tube being configured to route fuel downstream the first fuel reformer such that the unreformed fuel reacts with water of the exhaust fluid.
